(19) United States
(12) Patent Application Publication
(10) Pub. No.: US 2008/0231187 A1
(43) Pub. Date: Sep. 25, 2008

(54) Plasma display panel and method of manufacturing the same

(76) Inventors: Yong-Shik Hwang, Suwon-si (KR); Won-Ju Yi, Suwon-si (KR); Kyoung-Doo Kang, Suwon-si (KR); Tae-Seung Cho, Suwon-si (KR); Byoung-Min Chun, Suwon-si (KR); Jong-Woo Choi, Suwon-si (KR)

Correspondence Address: CHRISTIE, PARKER & HALE, LLP, PO BOX 7068, PASADENA, CA, 91109-7068, US

(21) Appl. No.: 12/077,867

(22) Filed: Mar. 19, 2008

(30) Foreign Application Priority Data
Mar. 21, 2007 (KR) 10-2007-0027819

(51) Int. Cl. H01J 17/49

(52) U.S. Cl. 313/582; 205/704

(57) ABSTRACT

A plasma display panel including: a first substrate; a second substrate separated from the first substrate; and two or more electrode sheets facing each other and between the first and second substrates, each of the two or more electrode sheets including opening patterns to form discharge spaces, wherein each of the two or more electrode sheets includes: a plurality of discharge electrodes extending in a direction and surrounding at least a part of the discharge spaces, and having corners with round curved portions contacting the discharge spaces or adjacent to the discharge spaces; and an insulating member integrally formed between the discharge electrodes for supporting the discharge electrodes and for insulating the discharge electrodes from each other, and including an oxide of a metal used to form the discharge electrodes.

### CROSS-REFERENCE TO RELATED PATENT APPLICATIONS

This application claims priority to and the benefit of Korean Patent Application No. 10-2007-0027819, filed on Mar. 21, 2007, in the Korean Intellectual Property Office, the entire content of which is incorporated herein by reference.

### BACKGROUND OF THE INVENTION

1. Field of the Invention

The present invention relates to a plasma display panel for displaying images using a gas discharge and a method of manufacturing the plasma display panel.

2. Description of the Related Art

Flat panel display apparatuses that utilize plasma display panels are relatively thin and light weight, have good image quality, large screen, and wide viewing angle, and can be easily manufactured to large sizes using simple fabrication methods.

Plasma display panels can be classified into a direct current (DC) type, an alternating current (AC) type, or a hybrid type according to a driving method thereof. In addition, the plasma display panels can be classified into an opposing discharge type or a surface discharge type according to a discharge structure. An example of a surface discharge type plasma display panel is a three-electrode surface discharge plasma display panel.

The three-electrode surface discharge plasma display panel has a three-electrode surface discharge structure. In order to solve problems of the three-electrode surface discharge structure such as degradation of phosphor material, reduction of visible ray transmittance, and reduction of light emission efficiency, research into plasma display panels having a new structure has been actively performed.

FIG. 1 is an exploded perspective schematic of a plasma display panel disclosed in Korean Patent Laid-open Publication No. 2005-0104003. The plasma display panel includes a front substrate 10 and a rear substrate 20 facing the front substrate 10 with a set distance therebetween. Front barrier ribs 31 and rear barrier ribs 24 are arranged to define a plurality of discharge spaces (S), and are between the substrates 10 and 20. In the front barrier ribs 31, first discharge electrodes 35 and second discharge electrodes 45 are separated from each other to create a display discharge in the discharge spaces (S). Front barrier ribs 31 completely cover the discharge electrodes 35 and 45 to prevent (or protect) the electrodes from being damaged by ion collisions, and to provide an environment for a proper discharge, and the front barrier ribs 31 are formed of a dielectric material. A phosphor material 25 is applied in regions defined by the rear barrier ribs 24. In addition, address electrodes 22 that extend in a direction crossing the discharge electrodes 35 and 45 are disposed on the rear substrate 20, and a dielectric layer 21, covering the address electrodes 22, is disposed between the rear substrate 20 and the rear barrier ribs 24.

In the plasma display panel of FIG. 1, the discharge occurs through side walls defining each of the discharge spaces (S), and thus, the phosphor material 25 applied on the rear substrate 20 is not degraded by the ion collisions. In addition, opaque electrodes on the front substrate 10 side are removed, and thus, upward transmittance of the visible rays is improved. Also, the discharge can occur through the all of the side walls of the discharge space (S) and the plasma can be concentrated onto a center portion of the discharge space (S), and thus, generation of ultraviolet rays can increase.

However, due to the structure of the plasma display panel, in which the discharge electrodes 35 and 45 are covered in the barrier rib 31, there is a difficulty in mass-producing this type of plasma display panel because of its complex manufacturing processes.

### SUMMARY OF THE INVENTION

Aspects of embodiments of the present invention are directed toward a plasma display panel having an improved structure for allowing high light emission efficiency and for mass-production, and a method of manufacturing the plasma display panel.

Other aspects of embodiments of the present invention are directed toward a plasma display panel having improved discharge stability and an improved durability, and a method of manufacturing the plasma display panel.

An embodiment of the present invention provides a plasma display panel including: a first substrate; a second substrate separated from the first substrate; and two or more electrode sheets facing each other and between the first and second substrates, each of the two or more electrode sheets including opening patterns to form discharge spaces, wherein each of the two or more electrode sheets includes: a plurality of discharge electrodes extending in a direction and surrounding at least a part of the discharge spaces, and having corners with round curved portions contacting the discharge spaces or adjacent to the discharge spaces; and an insulating member integrally formed between the discharge electrodes for supporting the discharge electrodes and for insulating the discharge electrodes from each other, and including an oxide of a metal used to form the discharge electrodes.

Another embodiment of the present invention provides a plasma display panel including: a first substrate; a second substrate separated from the first substrate; and a first electrode sheet and a second electrode sheet facing each other and between the first and second substrates, each of the first and second electrode sheets including opening portions to form discharge spaces, wherein each of the first and second electrode sheets includes: a plurality of discharge electrodes extending in a direction and surrounding at least a part of the discharge spaces, and having corners with round curved portions contacting the discharge spaces or adjacent to the discharge spaces; and an insulating layer forming vertical steps with the discharge electrodes and including an oxide of a metal used to form the discharge electrodes, the insulating layer being for supporting the discharge electrodes and for insulating the discharge electrodes from each other.

Another embodiment of the present invention provides a plasma display panel including: a first substrate; a second substrate separated from the first substrate; and a first electrode sheet and a second electrode sheet facing each other and between the first and second substrates, each of the first and second electrode sheets including opening patterns to form discharge spaces, wherein each of the first and second electrodes sheets includes: a plurality of discharge electrodes including discharging portions, and conductive portions electrically connecting the discharging portions to each other, each of the discharging portions including a discharge surface surrounding a corresponding one of the discharge spaces and a corner with a round curved portion contacting a discharge surface of the corresponding one of the discharge spaces; and at least one bridge integrally formed between adjacent discharge electrodes to support the discharge electrodes and to insulate the discharge electrodes from each other.

An embodiment of the present invention provides a method of manufacturing a plasma display panel including a plurality of discharge spaces arranged in arrays, a plurality of discharge electrodes extending in a direction and surrounding at least a part of the discharge spaces, and an insulating layer connecting the discharge electrodes and electrically isolating the discharge electrodes from each other, the method including: preparing a raw material metal sheet; forming a first photoresist (PR) mask to cover portions where the discharge electrodes are to be formed on a surface of the raw material metal sheet; forming a second PR mask to cover portions where the discharge electrodes are to be formed on another surface of the raw material metal sheet; selectively etching the surface of the raw material metal sheet exposed by the first PR mask; selectively etching the another surface of the raw material metal sheet exposed by the second PR mask; separating the first PR mask and the second PR mask; performing an anodizing process for oxidizing the raw material metal sheet in a neutral electrolysis solution to form an oxide film on surfaces of the discharge electrodes and for insulating portions between the discharge electrodes to form the insulating layer; repeating the preparing process, the two forming processes, the two etching processes, the separating process, and the performing process to fabricate at least two metal sheets; stacking the at least two metal sheets to face each other; and coupling a first substrate and a second substrate to each other while interposing the stacked metal sheets using a frit sealing material.

### BRIEF DESCRIPTION OF THE DRAWINGS

The accompanying drawings, together with the specification, illustrate exemplary embodiments of the present invention, and, together with the description, serve to explain the principles of the present invention.

The patent or application file contains at least one drawing/picture executed in color. Copies of this patent or patent application publication with color drawings/pictures will be provided by the Office upon request and payment of the necessary fee.

FIG. 1 is an exploded perspective schematic of a plasma display panel disclosed in Korean Laid-open Patent No. 2005-0104003;

FIG. 2 is an exploded perspective schematic of a plasma display panel according to an embodiment of the present invention;

FIG. 3 is a cross-sectional schematic of the plasma display panel taken along line III-III and III′-III′ of FIG. 2;

FIG. 4 is a perspective schematic showing an arrangement of electrodes in the plasma display panel of FIG. 2;

FIGS. 5 and 6 are cross-sectional schematics showing oxide films obtained by utilizing an oxidation process for aluminum products having a sharp corner and a rounded corner, respectively;

FIG. 7 is a micrograph of an oxide film around an aperture damaged by an application of a voltage;

FIG. 8 is an exploded perspective schematic of a plasma display panel according to another embodiment of the present invention;

FIG. 9 is a cross-sectional schematic of the plasma display panel taken along line VII-VII and line VII′-VII′ of FIG. 8;

FIG. 10 is an enlarged perspective schematic of an electrode sheet shown in FIG. 8;

FIGS. 11A, 11B, 11C, 11D, 11E, 11F, 11G, 11H and 11I are cross-sectional schematics illustrating a method of manufacturing a plasma display panel according to an embodiment of the present invention;

FIG. 12 is a schematic processing view illustrating an anodizing process of an embodiment of the present invention;

FIG. 13 is a cross-sectional perspective schematic showing a structure of an oxide film; and

FIG. 14 is a micrograph showing a structure of an oxide film fabricated according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

### FIRST EMBODIMENT

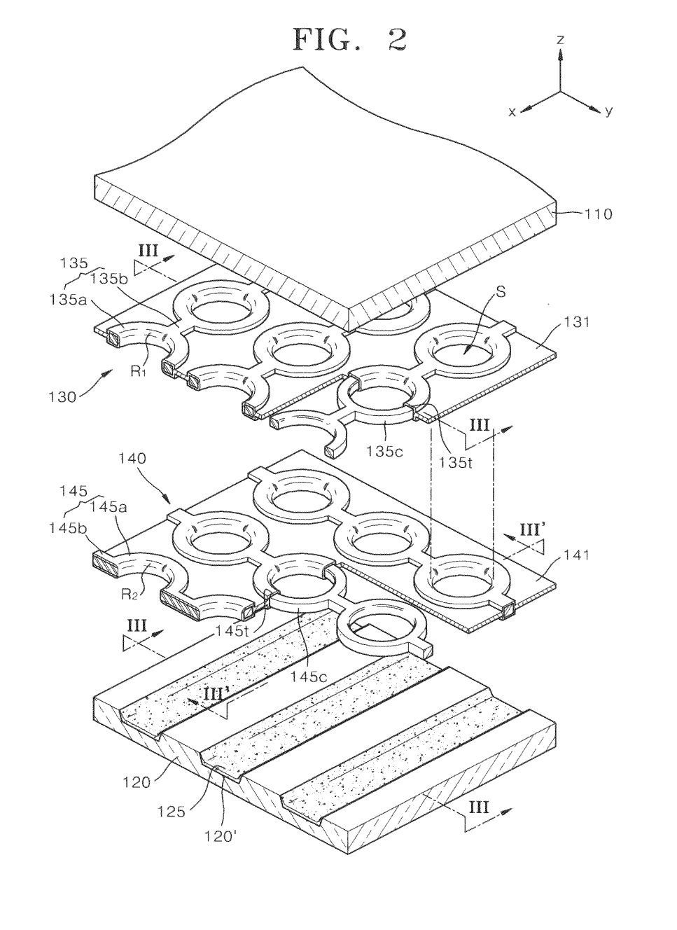

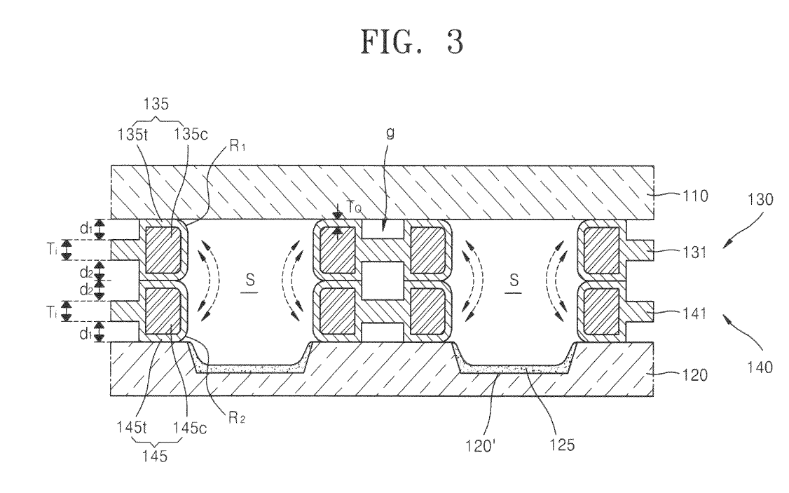

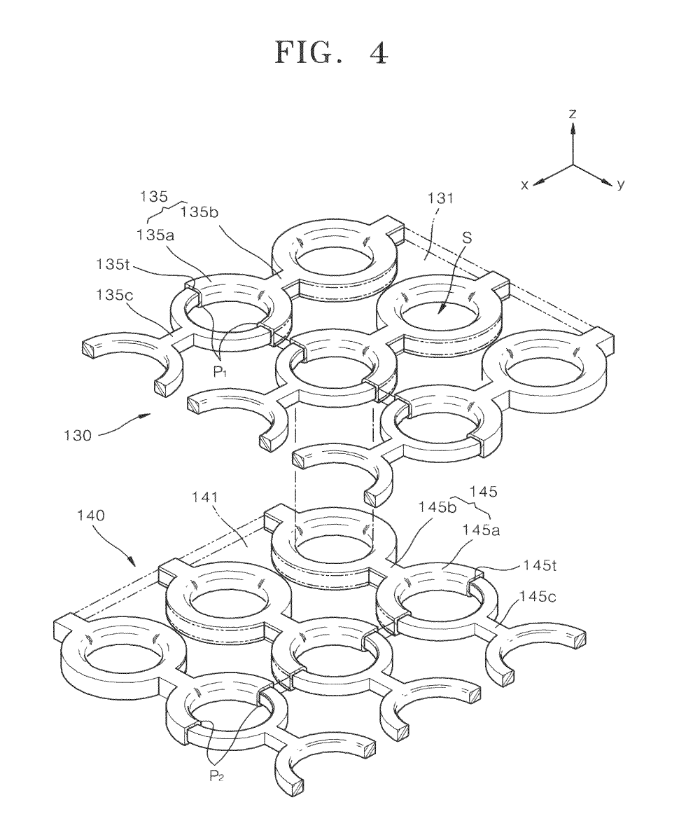

FIG. 2 is an exploded perspective schematic of a plasma display panel according to an embodiment of the present invention, and FIG. 3 is a cross-sectional schematic of the plasma display panel taken along line III-III of FIG. 2. For the convenience of explanation, the cross-section of FIG. 3 shows a second electrode sheet 140 taken along line III′-III′ of FIG. 2. In addition, FIG. 4 is an enlarged perspective schematic of discharge electrodes 135 and 145 shown in FIG. 2.

The plasma display panel includes a front (or first) substrate 110 and a rear (or second) substrate 120 facing the front substrate 110 with a distance therebetween (that may be predetermined). A first electrode sheet 130 and a second electrode sheet 140 are arranged to face each other to form a plurality of discharge spaces S, and are between the front substrate 110 and the rear substrate 120. The front substrate 110 is a surface for displaying images, and thus, the front substrate 110 according to an embodiment is a glass substrate having suitable light transmittance properties.

Each of the first electrode sheet 130 and the second electrode sheet 140 is an integrated sheet formed by utilizing an electrode pattern (that may be predetermined) on a metal sheet that is utilized as a raw material, and then, oxidizing the metal sheet to insulate a part of the metal sheet. Hereinafter, structures of the first and second electrode sheets 130 and 140 will be described in more detail. A plurality of openings arranged in longitudinal (vertical) and latitudinal (horizontal) directions are formed in each of the first and second electrode sheets 130 and 140, and the plurality of discharge spaces S are formed by combinations of the openings formed at corresponding positions. Here, each of the discharge spaces S is a space where an electric field (or a predetermined electric field) for generating a display discharge occurs and where a discharge gas that is excited by the discharge is filled. In the present embodiment, since the first and second electrode sheets 130 and 140 are disposed to face each other and form the discharge spaces S together, upper and lower portions formed by the first and second electrode sheets 130 and 140 become the parts of the discharge spaces S. In the present application, the portions formed by the sheet 130 or 140 may be referred to as the discharge spaces S for the convenience of explanation, but, the portions formed by the sheets 130 and 140 actually form only parts of the discharge space S.

Since the circular opening patterns are formed in the first and second electrode sheets 130 and 140, each of the discharge spaces S is formed as a cylinder. However, the present invention is not thereby limited. For example, when polygonal opening patterns are formed in the first and second electrode sheets 130 and 140, each of the discharge spaces S can be formed as various suitable polyhedron shapes including a hexahedron shape. In addition, the shape of the discharge space S is not limited as long as the discharge gas can be filled in the discharge space S.

A plurality of first discharge electrodes 135, extending in a first direction (x direction) and surrounding the discharge spaces S, are formed in the first electrode sheet 130. The first discharge electrode 135 may be formed of a metal material having a high electric conductivity in order to minimize (or reduce) a heat loss due to its resistance, for example, the first discharge electrode 135 may be formed of an aluminum material. Each of the first discharge electrodes 135 includes a discharging portion 135a surrounding a corresponding discharge space S to participate in a discharge operation, and a conductive portion 135b connecting multiple discharging portions 135a electrically to each other and supplying a driving power to the discharging portions 135a. The discharging portion 135a defines the corresponding discharge space S in accordance with the shape of the discharging portion 135a, and thus, the shape of the discharging portion 135a can be suitably changed in order to form various types of discharge spaces according to embodiments of the present invention. A round curved portion R1 is formed along an inner surface of the discharging portion 135a that defines the discharge space S. The round curved portion R1 is formed as a loop along upper and lower corners of the discharging portion 135a. The round curved portion R1 will be described in more detail below.

Also, the discharging portion 135a is shown to completely surround the discharge space S in the drawings. However, the present invention is not thereby limited. For example, the discharging portion 135a can surround only a part of the discharge space S as long as it can induce an electric field that is large enough to generate the discharge in the discharge space S. However, this may contribute to limit the discharge current. Also, a part of the discharging portion 135a can be opened, and the opening portion can be a part of an insulating layer 131 forming a vertical step with respect to the discharging portion 135a.

In addition, an oxide film 135t is formed on an outer surface of the first discharge electrode 135 to a thickness that may be predetermined (To) using an oxidation process such as an anodizing. The inner portion of the first discharge electrode 135 covered by the oxide film 135t is not oxidized, and remains as a core portion 135c for maintaining the electric conductivity. The first discharge electrode 135 can be electrically insulated using the oxide film 135t. For example, the oxide film 135t can be formed of Al₂O₃ that is formed by oxidizing aluminum (Al). The oxide film 135t formed on the surfaces contacting the discharge space S prevents (or blocks) the discharge electrodes 135 and 145 from being directly electrically connected to each other, and prevents (or protects) the discharge electrode 135 from being damaged due to collisions with charged particles, that is, the oxide film 135t performs the function of a conventional dielectric layer.

The oxide film 135t for protecting the discharge electrodes 135 may be formed to have a sufficient thickness in consideration of a withstanding voltage characteristic, and the thickness (To) of the oxide film 135t can be configured by controlling processing conditions, such as an applied current in the oxidation process, a selection of an electrolyte, and/or a processing time. Since the surface of the first discharge electrode 135 is covered by the oxide film 135t, an electric short circuit between the first and second discharge electrodes 135 and 145 can be prevented (or blocked).

In relation to the formation of the oxide film 135t, the round curved portion R1 is formed along the edge of the discharging portion 135a, that contacts the discharge space S. In general, since the discharge spaces S are formed by punching the electrode sheet 130, the surface contacting the discharge space S is a cut-surface in the punching process, and sharp edges can be formed on the corners of the cut-surfaces. However, because an oxide material is formed from the exposed surface of the product in the oxidation process, such as the anodizing process, it is difficult to form the oxide material having a dense structure on the sharp edge formed by the cutting process. Therefore, in embodiments of the present invention, the round curved portion R1 is formed to remove the sharp edge so as to prevent (or protect) a base of growing the oxide film 135t from being weakened due to the sharp edge, and to form the oxide film 135t uniformly (or continuously) throughout the entire surface including the corner.

Also, an insulating layer 131 (integrated with the first discharge electrodes 135) is formed between the first discharge electrodes 135. The first discharge electrodes 135 structurally support each other through the insulating layer 131, and thus, fluttering of the first electrode sheet 130 or bending of the first electrode sheet 130 can be prevented (or reduced), and the first electrode sheet 130 can be easily handled in the manufacturing process. As shown in the drawings, the insulating layer 131 forms the entire region of the first electrode sheet 130 except for the portions of the first discharge electrodes 135. An opening can be formed on a part of the insulating layer 131 to prompt the oxidation process due to the characteristics of the anodizing process, that is, the oxidation occurs through the surface. Here, the oxidation can be performed through the lateral surfaces of the opening.

The insulating layer 131 is adapted to support the first discharge electrodes 135 structurally and to insulate between the first discharge electrodes 135. For example, when the portion corresponding to the insulating layer 131 is insulated by anodizing the aluminum sheet on which the electrode patterns are formed, the insulating layer 131 can be formed of Al₂O₃ that is an oxidized material of Al.

The insulating layer 131 forms a vertical step with respect to the first discharge electrodes 135 and is formed to have a relatively thin thickness (Ti). For example, the insulating layer 131 forms steps (or offsets) d1 and d2 on upper and lower portions thereof with respect to the first discharge electrode 135, and the thickness Ti of the insulating layer 131 is relatively thin. The thickness Ti of the insulating layer 131 can be determined by processing conditions in the anodizing process. During the oxidation process from the surface inwards through the anodizing process, the thickness of the insulating layer 131 may be thin enough to completely oxidize the portion corresponding to the insulating layer 131. If the portion corresponding to the insulating layer 131 is formed to be thicker than the thickness Ti, the inside of the insulating layer 131 connecting the first discharge electrodes 131 is not oxidized and maintains the electric conductivity. Therefore, the first discharge electrodes 135 can be electrically shorted through the insulating layer 131. As such, the thickness of the insulating layer 131, including a processing margin, should not be substantially thicker than Ti. In order to form the structures of the first discharge electrode 135 and the insulating layer 131 that have different thicknesses from each other, the portion of the insulating layer 131 is etched from both sides of the aluminum sheet that is the raw material to form the stepped structure with the first discharge electrodes 135. Here, if the steps (or offsets) d1 and d2 between the insulating layer 131 and the first discharge electrode 135 are set to be the same as each other, the etching process from both sides can be performed symmetrically, and thus, convenience of the operation can be improved.

Also, as long as the insulating layer 131 is formed to be thin, by which the inside of the insulating layer 131 can be completely oxidized through the oxidizing process, the steps (or offsets) d1 and d2 can be formed on both surfaces of the first discharge electrode 135, otherwise, a deep step (or offset) can be formed with respect to a surface of the first discharge electrode 135 and a flat surface at the same height of the other surface of the first discharge electrode 135 can be formed.

Also, the vertical steps (or offsets) d1 and d2 between the first discharge electrode 135 and the insulating layer 131 are set to be in different depths from each other so that the first discharge electrode 135 maintains the electric conductivity and the insulating layer 131 can be completely insulated under the same oxidation condition. In addition, stepped spaces (g) formed on upper and lower portions of the insulating layer 131 can be provided as an exhaust path and an inducing path of gases when an impurity gas in the discharge space S is exhausted and a discharge gas is filled in the discharge space S. Accordingly, times for exhausting-filling processes can be reduced, and the impurity of the discharge gas can be relatively high without having relatively high impurity gas in the discharge space S to improve the stability of the discharge operation.

The second electrode sheet 140 facing the first electrode sheet 130 is disposed under the first electrode sheet 130. The second electrode sheet 140 can have similar (or substantially the same) structure to that of the first electrode sheet 130. In more detail, a plurality of discharge spaces S are arranged on the second electrode sheet 140, and a plurality of second discharge electrodes 145, extending in a second direction (y direction) and surrounding the discharge spaces S, are formed in the second electrode sheet 140. Each of the second discharge electrodes 145 includes a discharging portion 145a surrounding a corresponding discharge space S to participate in a discharge operation, and a conductive portion 145b connecting multiple discharging portions 145a electrically to each other and supplying a driving power to the discharging portions 145a. That is, the inner portion of the second discharge electrode 145 covered by an oxide film 145t is not oxidized, and remains as a core portion 145c for maintaining the electric conductivity. A round curved portion R2 is formed along an edge of the discharging portion 145a that contacts the discharge space S.

The second discharge electrodes 145 can extend in the second (or y) direction crossing the first discharge electrodes 135 that extend in the first (or x) direction, and thus, one discharge electrode can be used as an address electrode and the other discharge electrode can used as a scan electrode to allow the selection of the discharge space S, in which the display discharge is to occur. For example, the first discharge electrode 135 can be used as the scan electrode, and the second discharge electrode 145 can be used as the address electrode.

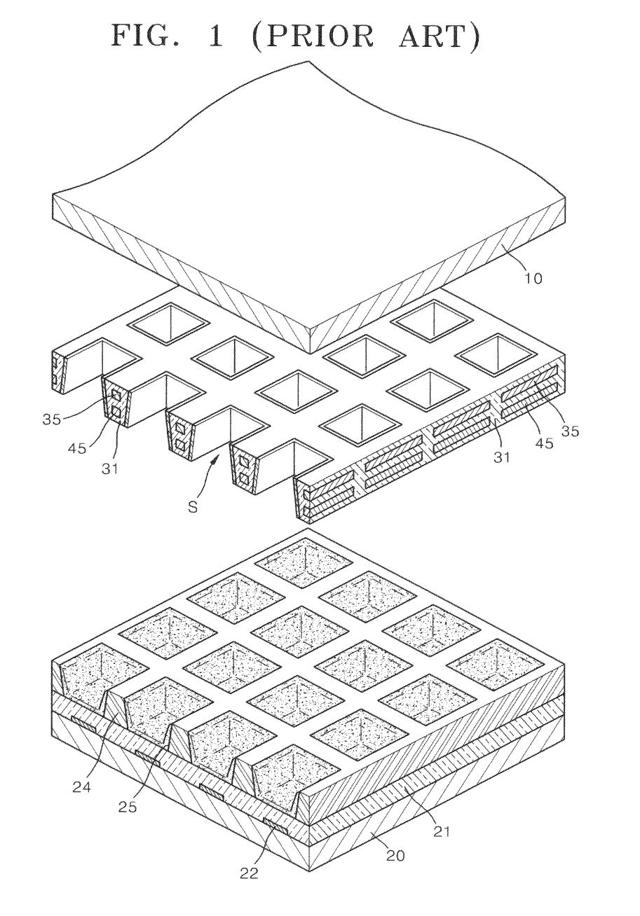

However, the technical scope of the present invention is not limited to the above electrode structure, and the present invention can be applied to a structure, in which the first and second discharge electrodes are arranged in parallel with each other and additional address electrodes extending in a direction crossing the discharge electrodes are formed (e.g., as shown in FIG. 1). Here, one of the first and second discharge electrodes can used as the scan electrode to generate an address discharge for selecting the discharge space with one of the address electrodes.

The second discharge electrodes 145 are supported by and insulated from each other by an insulating layer 141 filling regions between the second discharge electrodes 145. In addition, the insulating layer 141 is formed to have a relatively thin thickness (Ti) while forming steps (or offsets) d1 and d2 with the second discharge electrodes 145. In more detail, the insulating layer 141 can form the steps (or offsets) d1 and d2 with the upper and lower surfaces of the second discharge electrode 145 with the thin thickness Ti. Also, although it is not shown in the drawings, the first and second electrode sheets 130 and 140 can be coupled to each other using, for example, a dielectric adhesive layer that is not conductive therebetween.

The rear substrate 120 facing the front substrate 110 can be a glass substrate formed of glass. Grooves 120′ are formed on an inner surface of the rear substrate 120 to correspond to the discharge spaces S, and phosphors 125 are applied along the grooves 120′. The grooves 120′ define the application areas of the phosphor s125, and increase the application area of the phosphors 125. The phosphors 125 are applied in different colors in order to realize full-color display. For example, in a case where the color images are displayed using three primary colors, red, green, and blue phosphors 125 are applied alternately in the grooves 120′. In addition, a single color light such as red, green, or blue light is emitted from each of the discharge spaces S according to the kind of the applied phosphor 125, and the color images are displayed using the single color lights.

Hereinafter, operations of the plasma display panel will be described in more detail. When an alternating current (AC) voltage is applied to the first and second discharge electrodes 135 and 145, an electric field is formed in the discharge space S to cause a discharge, and thus, wall charges obtained from an address discharge and charged particles formed from an ionization of the discharge gas are moved along discharge paths between the discharge electrodes 135 and 145 to generate the display discharge. The display discharge occurs in a vertical direction as a closed loop shape through lateral surfaces of the discharge electrodes 135 and 145 that define the discharge space S. Therefore, the lateral surfaces of the discharge electrodes 135 and 145 become the discharge surface. The discharge gas filled in the discharge space S is excited by collisions with the charged particles moving along the discharge path, and then, stabilizes to a base state to generate ultraviolet rays corresponding to an energy difference between the excited state and the base state. The ultraviolet rays are converted into visible rays through the phosphor 125, and the visible ray is projected toward the front substrate 110 to display a image (that may be predetermined) to be recognized by the user.

Hereinafter, operations of the curved portions R1 and R2 formed in the discharge electrodes 135 and 145 will be described in more detail. As described above, the round curved portions R1 and R2 are formed on the corners of the first and second discharge electrodes 135 and 145 contacting the discharge space S. The discharge surface neighboring the curved portions R1 and R2 corresponds to the cut surface that is formed when the raw material plate is perforated in order to form the opening for forming the discharge space. Therefore, the sharp edge is generally formed along the corner neighboring the discharge surface. In the present embodiment, a finishing operation is performed along the corner of the discharge surface to remove the sharp edge, and accordingly, the curved portions R1 and R2 are formed as a result of the finishing operation. Here, the finishing operation may be a polishing operation for fine cutting operation, for example, a chemical mechanical polishing (CMP) using a polishing pad of a CMP apparatus or a manual operation using a sandpaper to remove the sharp edge.

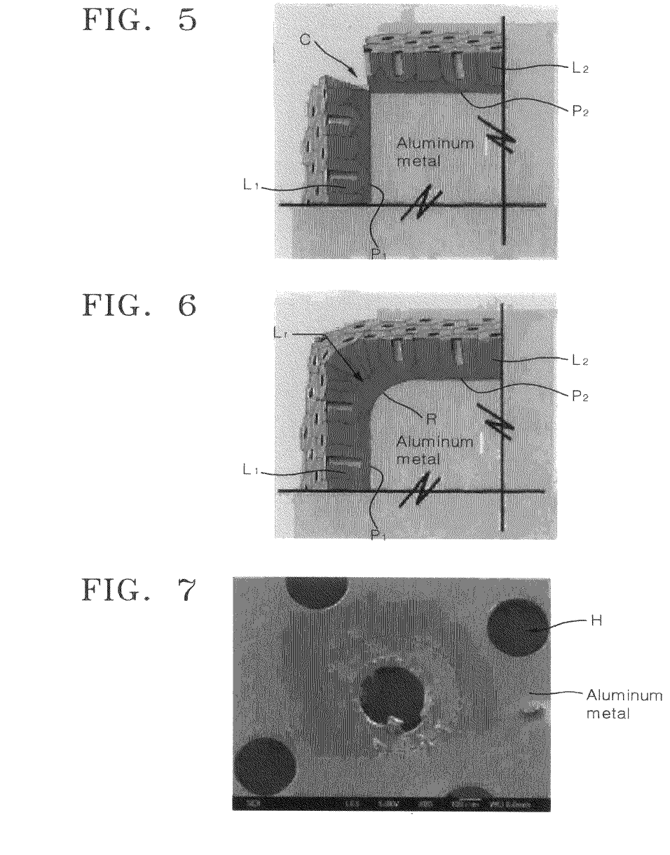

FIG. 5 is a cross-sectional schematic showing an oxide film obtained by performing an oxidation process with respect to an aluminum product having a sharp edge, and FIG. 6 is a cross-sectional schematic of an oxide film obtained by performing an oxidation process with respect to an aluminum product having a curved portion R on a corner portion thereof. External oxygen is infiltrated into the product through the surface of the product in the oxidation process such as the anodizing process, and aluminum component of the product is diffused outward through the surface of the product, and then, the oxygen and the aluminum react with each other to form the oxide film. The oxide film has a tendency to grow in a direction perpendicular to the surface of the product, and thus, as shown in FIG. 5, when the corner on which a first surface P1 and a second surface P2 meet each other is sharply angled, a crack (C) where the oxide film does not exist can be formed between a first oxide film (L1) growing from the first surface P1 and a second oxide film (L2) growing from the second surface P2. The crack C may not be formed between the oxide films due to a detailed oxidation condition, for example, a processing time or an applied current, however, the oxide film formed on the corner portion cannot provide sufficient insulating property due to sparse inner structure and can be easily damaged due to a low withstanding voltage.

As described above, oxide films 135t and 145t formed on surfaces of the first and second discharge electrodes 135 and 145 prevent (or protect) the first and second discharge electrodes 135 and 145 from being directly electrically connected to each other, and protects the first and second discharge electrodes 135 and 145 from ion shock in a manner similar to a conventional dielectric layer. Therefore, if the oxide films 135t and 145t are not evenly covered onto the inner surfaces of the first and second discharge electrodes 135 and 145 contacting the discharge space S and there is a crack C in the oxide films 135t and 145t, the withstanding voltage is greatly reduced. In particular, the electric field is concentrated onto the corner where the crack C is likely to be formed, and thus the insulating property is damaged and a direct short can be generated between the first and second discharge electrodes 135 and 145.

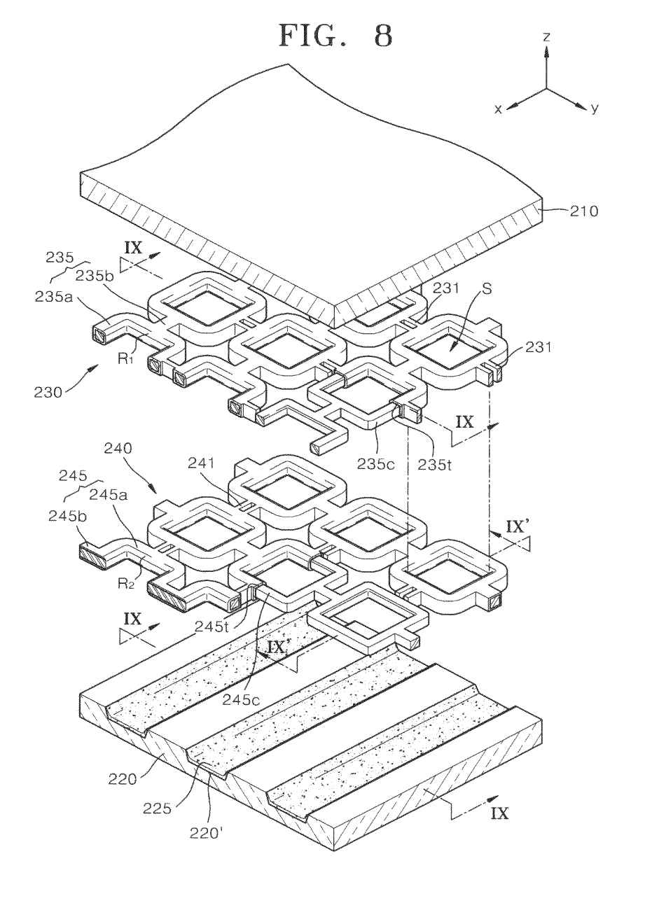

FIG. 7 shows a damaged oxide film around an opening (H) where the oxide film is formed on an aluminum plate on which multiple openings H are formed and when a set discharge voltage is applied. The insulating property is damaged when the oxide film having a dense structure cannot be formed on the sharp corner formed by perforating the openings H due to the above limitation in the oxidation process, and the electric field is concentrated and arcing is generated.

By contrast, as shown in FIG. 6, when the round curved portion R is formed on the corner of the product, a rounded oxide film Lr is grown from the curved portion R with the first and second oxide films L1 and L2, and thus, the oxide film can be evenly formed along the surface of the product. The round curved portion R provides a base for growing the oxide film, and thus, increases the withstanding voltage and improves a durability of the display panel.

### SECOND EMBODIMENT

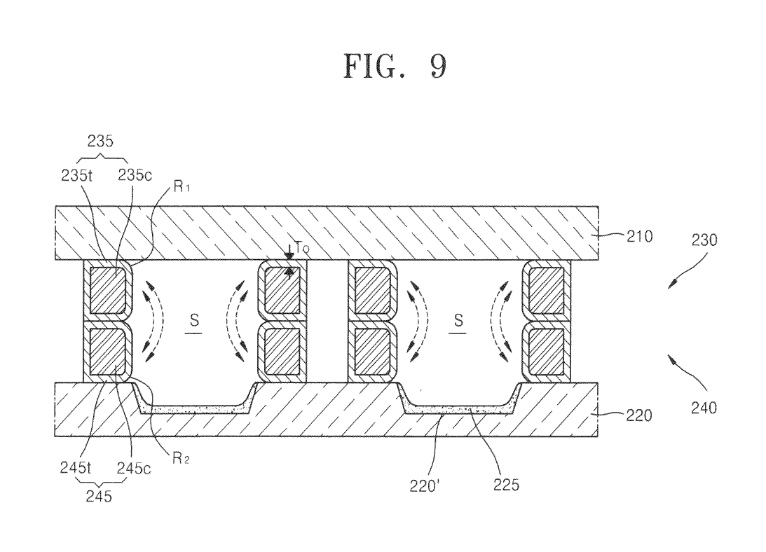

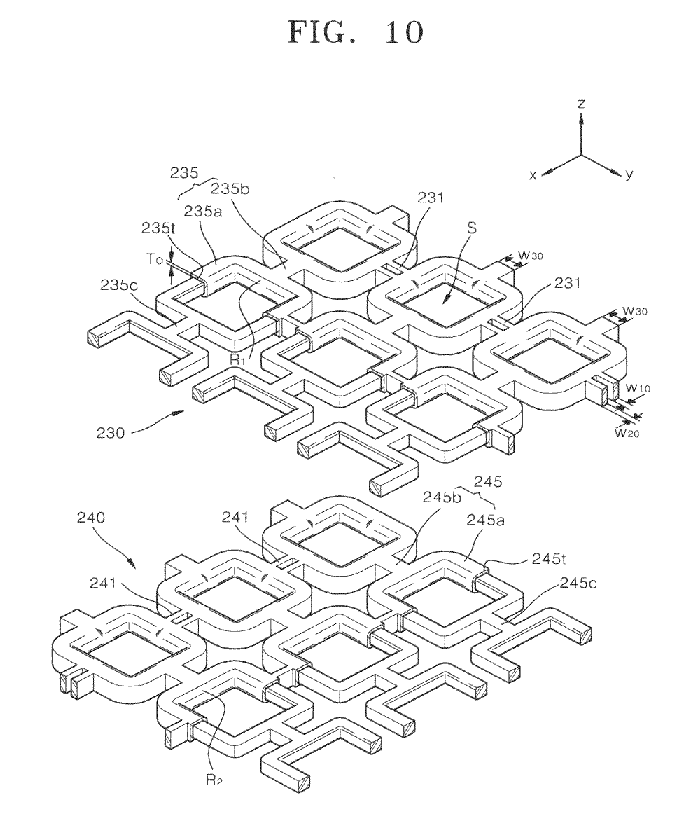

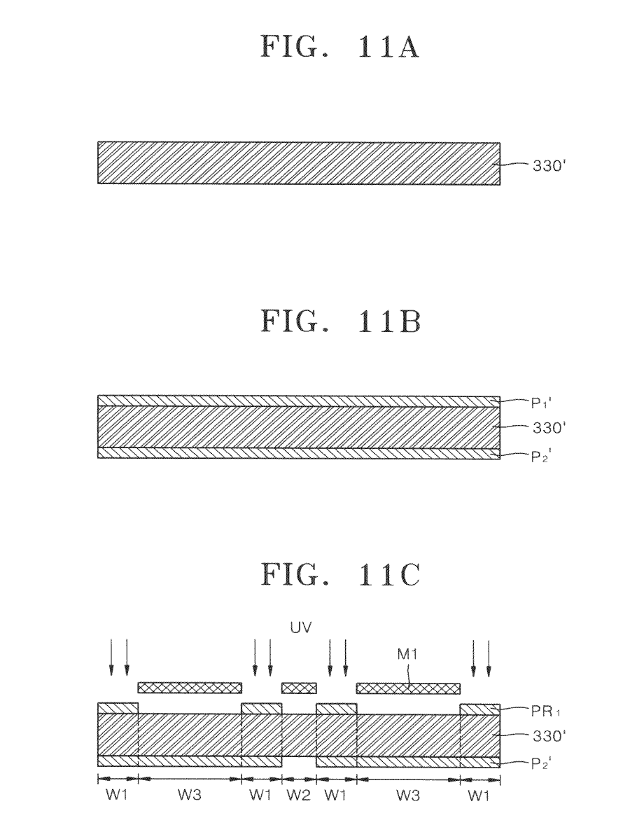

FIG. 8 is an exploded perspective schematic of a plasma display panel according to another embodiment of the present invention, and FIG. 9 is a cross-sectional schematic of the plasma display panel taken along line IX-IX of FIG. 8. For the convenience of explanation, the cross-section of the second electrode sheet 240 is taken along line IX′-IX′ of FIG. 8. In addition, FIG. 10 is an exploded perspective schematic of parts of electrode sheets 230 and 240 shown in FIG. 8. The plasma display panel includes a front (or first) substrate 210 and a rear (or second) substrate 220 facing the front substrate 210. A first electrode sheet 230 and a second electrode sheet 240 are arranged to face each other, and are between the substrates 210 and 220 to form discharge spaces S. Each of the first and second electrode sheets 230 and 240 is an integrated sheet composed of discharge electrodes 235 and 245 and bridges 231 and 241. The bridges 231 and 241 are for connecting the discharge electrodes 235 and 245 on a metal sheet, are for insulating the first and second electrodes 235 and 244, and are formed using an oxidation process. The metal sheet can be an aluminum sheet having a high electric conductivity in consideration of an electric power loss due to a resistance of the discharge electrode and being insulated easily through the oxidation process.

In more detail, the first electrode sheet 230 includes a plurality of first discharge electrodes 235 surrounding the discharge spaces S and extending in a first direction (x direction). Each of the first discharge electrodes 235 includes a discharging portion 235a surrounding a corresponding discharge space S, and a conductive portion 235b connecting the discharging portions 235a electrically. The discharging portion 235a surrounds the corresponding discharge space S to define the discharge space S as an independent light emitting region. In addition, the discharging portion 235a causes a display discharge in the corresponding discharge space S with another discharging portion 245a. A round curved portion R1 is formed on a corner of the discharging portion 235a contacting the discharge space S. Therefore, a base surface from which an oxide film 235t can be grown can be provided by the curved portion R1, and thus, the oxide film 235t can be formed evenly on a discharge surface contacting the discharge space S.

The conductive portion 235b allows the discharging portions 235a to be separated from each other with a distance therebetween, and to be electrically connected to each other in the first (or x) direction. Also, the discharging portions 235a arranged in a same row share the same driving signal so as to form one discharge electrode 235. The conductive portion 235b has electric conductivity, and the conductive portion 235b should have a sufficient width W30 so that the conductivity can be maintained on an inner core 235c even though the surface of the conductive portion 235b is oxidized, when some parts of the electrode sheet 230 are insulated using an anodizing process. That is, the width W30 of the conductive portion 235b should be formed wide enough so as to allow the core portion 235c to maintain electric conductivity and so that oxygen does not infiltrate into the core portion 235c in the width direction when the anodizing process is completed. As a result of the oxidation process, the oxide film 235t is formed along the surface of the first discharge electrodes 235 to a thickness To. The oxide film 235t formed on the surface of the discharge electrode 235 surrounding the discharge space S prevents (or protects) the discharge electrodes 235 and 245 from being directly electrically connected to each other, and protects the discharge electrode 235 from ion shock generated due to the discharge. The first and second discharge electrodes 235 and 245 arranged in the vertical direction can be electrically insulated from each other by the oxide film 235t.

The neighboring first discharge electrodes 235 are structurally supported by each other through the bridge 231 connecting the first discharge electrodes 235 to each other. The bridge 231 connects the first discharge electrodes 235 to each other to prevent (or protect) the first electrode sheet 230 from fluttering or bending. The bridge 231 extends in a second direction (y direction) crossing the first direction where the discharge electrodes 235 are arranged. Also, one or more bridges 231 can be formed in parallel with each other in consideration of a supporting strength required by the electrode sheet 230.

The bridge 231 is formed of an insulating oxide material to insulate the neighboring discharge electrodes 235 from each other, and to prevent (or protect) the discharge electrodes 235 to which different driving signals are input from being electrically shorted. In more detail, the discharging portions 235a surrounding the discharge spaces S are electrically connected to each other by the conductive portion 235b in the x direction, and insulated from each other by the bridge 231 in the y direction. The bridge 231 can be formed between the discharging portions 235a adjacent to each other. Also, the bridge 231 can be formed between the conductive portions 235b if it can insulate and support the discharge electrodes 235 adjacent to each other.

Widths W10 and W20 of the bridges 231 may be formed to be sufficiently narrow so that the entire bridge 231 can become an insulator by the oxidation process that is formed from the surfaces of the bridge 231. Since the conductive portion 235b includes the core portion 235c to maintain electric conductivity and the bridge 231 should be insulated entirely under the same oxidation condition, the following relation between the width W30 of the conductive portion 235b and the widths W10 and W20 of the bridges 231 should be achieved.

W30>W10, W20

The second electrode sheet 240 arranged in a vertical direction with the first electrode sheet 230 has similar (or substantially the same) structure to that of the first electrode sheet 230. That is, the second electrode sheet 240 includes a plurality of discharge spaces S arranged in transverse and longitudinal directions, and a plurality of second discharge electrodes 245 surrounding the discharge spaces S and extending in the second direction (y direction) are disposed in the second electrode sheet 240. The second discharge electrodes 245 can extend in the y direction crossing the first direction in which the first discharge electrodes 235 extend. The discharge space S in which the display discharge will occur can be selected through the first and second discharge electrodes 235 and 245 crossing each other.

The second discharge electrode 245 includes a discharging portion 245a defining corresponding discharge spaces S and participating in the discharge operation, and a conductive portion 245b electrically connecting the discharging portions 245a. That is, the conductive portion 245b has electric conductivity, and the conductive portion 245b should have a sufficient width so that the conductivity can be maintained on an inner core 245c even though the surface of the conductive portion 245b is oxidized. A round curved portion R2 is formed on a corner of the discharging portion 245a contacting the discharge space S. The curved portion R2 provides a base surface from which an oxide film 245t having a dense structure is grown. Also, the second discharge electrodes 245 are structurally supported by bridges 241 connecting the second discharge electrodes 245, and electrically insulated from each other. In more detail, the discharging portions 245a surrounding the discharge spaces S are electrically connected to each other by the conductive portion 245b in the y direction, and electrically insulated from each other by the bridge 241 in the x direction.

The front substrate 210 and the rear substrate 220 can be glass substrates formed of glass. In addition, a plurality of grooves 220′ can be formed on an inner surface of the rear substrate 220 with intervals that may be predetermined so as to correspond to the discharge spaces S. Phosphors 225 are applied in the grooves 220′. Although it is not shown in the drawings, the phosphors 225 can be applied on the front substrate 210, and thus, grooves for defining the application area of the phosphors 225 can be formed on the front substrate 210.

### THIRD EMBODIMENT

Hereinafter, a method of manufacturing a plasma display panel according to an embodiment of the present invention is described in more detail. According to the current embodiment, an internal structure of the oxide film is changed by controlling a processing condition in the anodizing process, and accordingly, a plasma display panel having an improved structure for withstanding voltage can be provided.

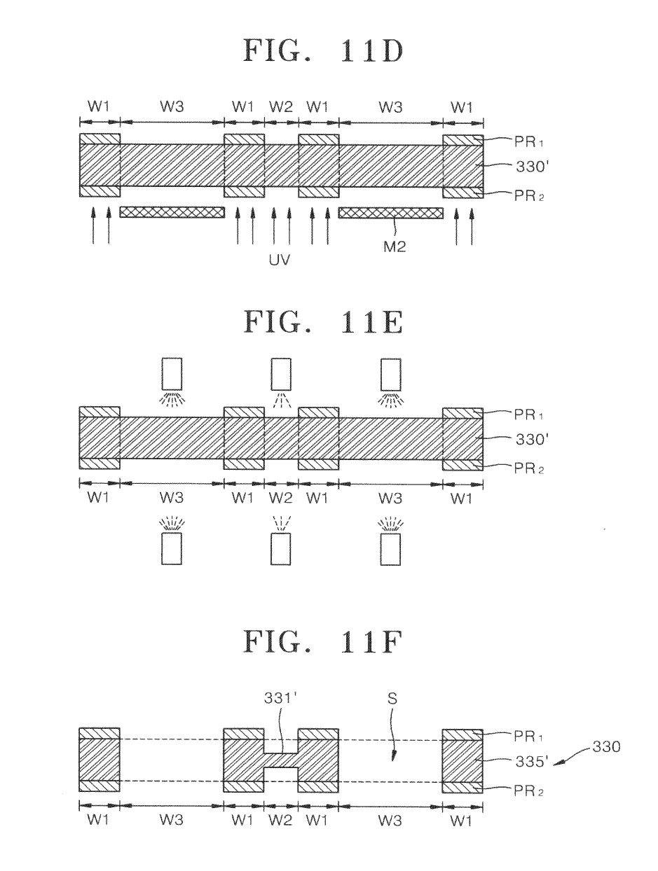

FIGS. 11A through 11I illustrate a method of manufacturing the plasma display panel according to the current embodiment of the present invention. As shown in FIG. 11A, a metal sheet that is a raw material of the first electrode sheet is prepared. In one embodiment, the metal sheet is an aluminum sheet 330′ having a high electric conductivity and a high chemical attraction to the oxygen.

Next, as shown in FIG. 11B, a first photoresist P1′ and a second photoresist P2′ are applied on upper and lower surfaces of the aluminum sheet 330′. The first and second photoresists P1′ and P2′ can be formed of a photosensitive resin material that is cured when it is exposed to an irradiation light, such as ultraviolet (UV) ray.

Next, referring to FIG. 11C, an exposure process irradiating the UV ray selectively to the first photoresist P1 using an exposure mask M1 and a development process are performed, and then, a first photoresist (PR) mask PR1 having a pattern (that may be predetermined) is formed as shown in FIG. 11C. The first PR mask PR1 has the pattern corresponding to parts W1 of discharge electrodes, and covers the corresponding parts W1.

Next, referring to FIG. 11D, the exposure and the development processes are performed with respect to the second photoresist P2′ using an exposure mask M2, and then, a second PR mask PR2 having a pattern (that may be predetermined) is formed as shown in FIG. 11D. The second PR mask PR2′ has a pattern corresponding to the parts W1 of the discharge electrodes, and covers the parts W1. The first PR mask PR1 and the second PR mask PR2 formed on the upper and lower surfaces of the aluminum sheet 330′ may be arranged to have a perpendicular step (or offset) from each other. In an etching process that will be described later, the aluminum sheet 330′ is etched from both surfaces using the first and second PR masks PR1 and PR2 to form the discharge spaces. Here, if a mis-alignment is generated due to the inaccurate arrangement of the first and second PR masks PR1 and PR2, the discharge spaces do not coincide, and the display function of the panel may be degraded.

As shown in FIGS. 11E and 11F, the upper surface of the aluminum sheet 330′ is etched using the first PR mask PR1 as an etch-stop layer. Parts of discharge spaces W3 and parts between the discharge electrodes W2 are selectively etched. Here, the parts of the discharge spaces W3 are full-etched, and the parts between the discharge electrodes W2 are half-etched.

In addition, as shown in FIGS. 11E and 11F, the lower surface of the aluminum sheet 330′ is etched using the second PR mask PR2 as an etch-stop layer. Through this etching process, the parts of the discharge spaces W3 and the parts between the discharge electrodes W2 are selectively etched. Here, the parts of the discharge spaces W3 are full-etched until the discharge spaces S are completely penetrated, and the parts between the discharge electrodes W2 are half-etched such that a set thickness remains.

Next, referring to FIG. 11G, the first and second PR masks PR1 and PR2 are separated, and then, an electrode sheet 330 having the structure of FIG. 11G is obtained. Some parts 335′ remained from the above etching process form the discharge electrodes, and the other parts 331′ form the insulating layer between the discharge electrodes.

In addition, as shown in FIG. 11H, an anodizing process for forming an oxide film 335t on the surface of the electrode sheet 330 is performed. The oxide film 335t formed along the surface of the electrode sheet 330 is formed of Al₂O₃, which is a ceramic material having an insulating property. Here, the discharge electrode 335 is formed to be relatively thick and includes a core portion 335c that is not oxidized to maintain properties of electric conductivity. Also, the part between the discharge electrodes that is formed to be relatively thin is completely oxidized and insulated so as to form the insulating layer 131 supporting the discharge electrodes 335 and insulating the discharge electrodes 335 from each other. The anodizing process is an element of an embodiment of the present invention, and will be described in more detail below.

Also, as shown in FIG. 11I, another electrode sheet 340 having substantially the same structure as that of the electrode sheet 330 can be obtained by repeating the above processes. The electrode sheet 340 includes an insulating layer 341 between discharge electrodes 345, and each of the discharge electrodes 345 is covered by the oxide film 345t includes a core portion 345c which maintains properties of electric conductivity. Next, the electrode sheets 330 and 340 are arranged substantially symmetrically to each other, and coupled to each other using an insulating adhesive 365. However, even if the electrode sheets 330 and 340 are not directly coupled to each other using the adhesive 365, the stacked structure of the electrode sheets 330 and 340 can be maintained by a coupling force between the front substrate 310 and the rear substrate 320, and thus, the adhesive 365 is an optional element.

Next, a front (or first) substrate 310 and a rear (or second) substrate 320 that will be disposed on upper and lower surfaces of the electrode sheets 330 and 340 are prepared. The front and rear substrates 310 and 320 can be glass substrates. In addition, grooves 320′ are formed on the rear substrate 320 with constant intervals therebetween, and phosphors 325 are applied onto the grooves 320′. The grooves 320′ correspond to the discharge spaces S formed in the electrode sheets 330 and 340. Then, the front and rear substrates 310 and 320 are arranged to face to each other while interposing the electrode sheets 330 and 340 therebetween, and then, the front and rear substrates 310 and 320 are coupled to each other using a frit sealing material 315 applied between the substrates 310 and 320.

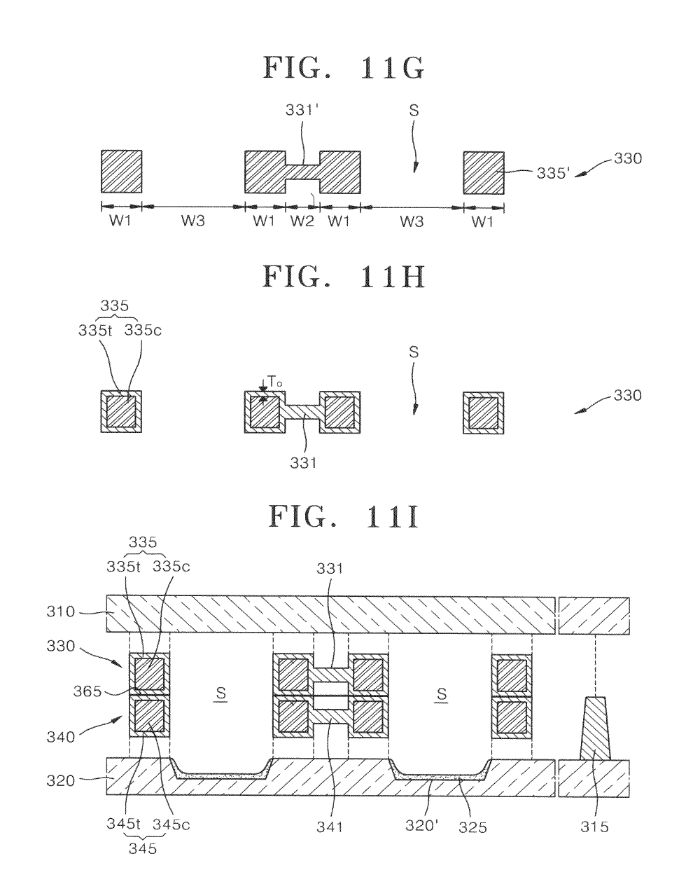

Hereinafter, the anodizing process of an embodiment of the present invention will be described in more detail. FIG. 12 schematically illustrates the anodizing process. In the anodizing process of the embodiment of the present invention, the aluminum sheet (Al), such as the aluminum sheet 330′, is an anode (+); and a conductive material (such as Pb, Carbon, Ni), and Pb for performing as a catalyst is a cathode in an electrolysis solution such as ammonium borates, ammonium phosphate, or ammonium tartrate. Under these conditions, a DC current is supplied to cause an electric-chemical reaction for forming an oxide film Al₂O₃ along the surface of the Al sheet. A thickness of the oxide film can be suitably controlled to be within a range, for example, from 1 μm to 50 μm, by adjusting the processing conditions such as the processing time or the magnitude of the DC current.

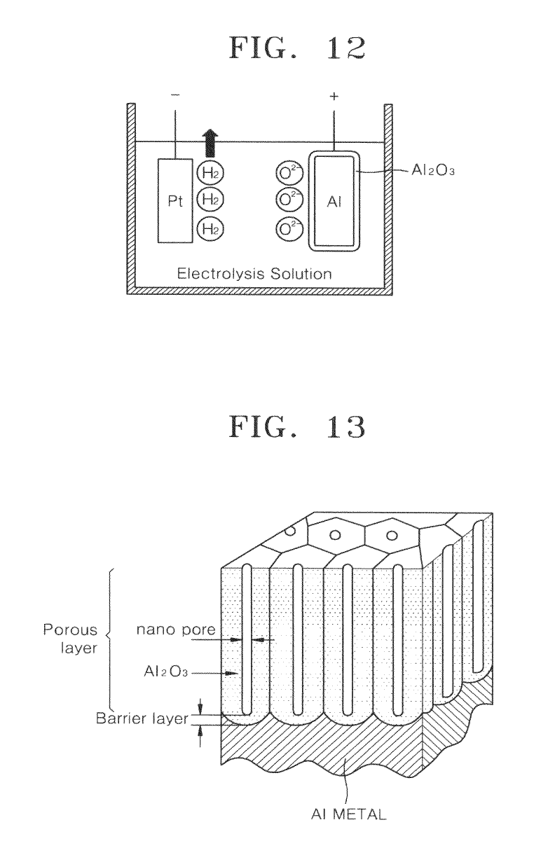

FIG. 13 is a diagram showing a vertical cross-section of the oxide film. The oxide film generally includes two thin films having different film characteristics from each other. A porous layer including nano-pores having diameters ranging from a few nm to 100 nm is formed on an external surface portion of the oxide film. Therefore, the porous layer has a relatively low electric insulating property. A barrier layer is formed between the porous layer and an Al metal under the porous layer, and the barrier layer has a dense structure without any pore so as to contribute to the improvement of the withstanding voltage. The withstanding voltage of the entire oxide film is dependent on the thickness of the barrier layer; however, the maximum thickness of the barrier layer is about 0.1 μm in a conventional anodizing process using sulfuric acid or oxalic acid as the electrolysis solution.

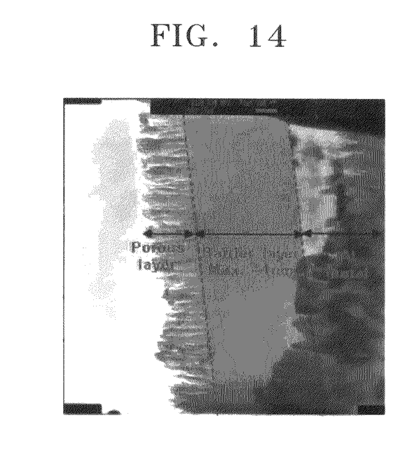

In the present invention, the neutral electrolysis solution such as ammonium borates, ammonium phosphate, or ammonium tartrate is used, and thus, a thicker barrier layer can be formed. When a voltage of 700 V is applied in the anodizing process, the barrier layer having a thickness of about 1 μm (or 1 μm) can be formed. FIG. 14 is an electron microscope photograph showing the vertical cross section of the oxide film obtained by the anodizing process of the present invention. As shown in FIG. 14, the thickness of the barrier layer increases, and the barrier layer having a maximum thickness of 1 μm can be formed by the anodizing process of the present invention.

According to an embodiment of the present invention, an oxide film for performing as the dielectric layer is formed on the surface of the discharge electrodes by oxidizing the metal sheet on which the patterns of the discharge electrodes are formed, and thus, additional processes for forming the dielectric layer are not required. In particular, a plasma display panel having an improved structure in which electrodes extend while surrounding the discharge spaces which is suitable for mass production is provided, and thus, the limitation in the conventional display panel of high efficiency can be overcome and the display panels can be suitably commercialized.

In addition, thicknesses or widths of the portions that will be electrically connected and the portions that will be insulated are set different from each other, and thus, the same oxidation process can be performed without an additional patterning process for performing a selective oxidation process to form the conductive portions and the insulated portions. Therefore, manufacturing processes can be minimized (or reduced).

In particular, according to an embodiment of the present invention, a round curved portion is formed on the corner of the discharge electrode contacting the discharge space to prevent (or protect) a growth base of the oxide film from being weakened and to form the oxide film evenly on the entire surface of the discharge electrode including the corner. Therefore, degradation of the discharging stability and the durability caused by the crack in the oxide film or the oxide film having a sparse structure can be prevented (or reduced) in advance.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a second substrate separated from the first substrate; and
two or more electrode sheets facing each other and between the first and second substrates, each of the two or more electrode sheets comprising opening patterns to form discharge spaces,
wherein each of the two or more electrode sheets comprises:
a plurality of discharge electrodes extending in a direction and surrounding at least a part of the discharge spaces, and having corners with round curved portions contacting the discharge spaces or adjacent to the discharge spaces; and
an insulating member integrally formed between the discharge electrodes for supporting the discharge electrodes and for insulating the discharge electrodes from each other, and comprising an oxide of a metal used to form the discharge electrodes.

2. The plasma display panel of claim 1, wherein each of the discharge electrodes is separated from one or more adjacent discharge electrodes so as to be driven independently.

3. The plasma display panel of claim 1, wherein the curve portions are formed along upper and lower corners of the discharge electrodes contacting the discharge spaces.

4. The plasma display panel of claim 1, wherein an oxide film is formed on a surface of the each of the discharge electrodes.

5. The plasma display panel of claim 1, wherein the discharge electrodes comprise substantially aluminum, and the insulating member comprises an alumina having an insulating property.

6. A plasma display panel comprising:
a first substrate;
a second substrate separated from the first substrate; and
a first electrode sheet and a second electrode sheet facing each other and between the first and second substrates, each of the first and second electrode sheets comprising opening portions to form discharge spaces,
wherein each of the first and second electrode sheets comprises:
a plurality of discharge electrodes extending in a direction and surrounding at least a part of the discharge spaces, and having corners with round curved portions contacting the discharge spaces or adjacent to the discharge spaces; and
an insulating layer forming vertical steps with the discharge electrodes and comprising an oxide of a metal used to form the discharge electrodes, the insulating layer being for supporting the discharge electrodes and for insulating the discharge electrodes from each other.

7. The plasma display panel of claim 6, wherein each of the discharge electrodes is separated from one or more adjacent discharge electrodes so as to be driven independently.

8. The plasma display panel of claim 6, wherein the curved portions are formed along upper and lower corners of the discharge electrodes contacting the discharge spaces.

9. The plasma display panel of claim 6, wherein the discharge electrodes comprise substantially aluminum, and the insulating layer comprises an alumina having an insulating property.

10. The plasma display panel of claim 6, wherein an oxide film having an insulating property is formed on a surface of each of the discharge electrodes.

11. The plasma display panel of claim 6, wherein each of the discharge electrodes comprises discharging portions surrounding the discharge spaces to participate in the discharge operation and conductive portions electrically connecting the discharging portions.

12. The plasma display panel of claim 11, wherein the curved portions are formed along inner edges of the discharging portions.

13. The plasma display panel of claim 6, wherein the discharge electrodes of the first electrode sheet extend in a first direction, and the discharge electrodes of the second electrode sheet extend in a second direction crossing the first direction.

14. The plasma display panel of claim 6, further comprising a plurality of address electrodes on the first substrate or the second substrate, wherein the discharge electrodes of the first electrode sheets extend in a first direction, the discharge electrodes of the second electrode sheets extend in a second direction parallel to the first direction, and the address electrodes extend in a third direction crossing the first direction and the second direction.

15. The plasma display panel of claim 6, wherein the insulating layer is thinner than the discharge electrodes and comprises vertical steps with the discharge electrodes.

16. The plasma display panel of claim 15, wherein a surface of the insulating layer forms the vertical steps with adjacent discharge electrodes, and another surface of the insulating layer forms a flat surface with the discharge electrodes.

17. The plasma display panel of claim 15, wherein upper and lower surfaces of the insulating layer form the vertical steps with adjacent discharge electrodes.

18. The plasma display panel of claim 6, wherein the insulating layer comprises an entire region of the electrode sheet except for the discharge electrodes.

19. The plasma display panel of claim 6, wherein a plurality of grooves are formed on at least one of the first substrate or the second substrate to correspond to the discharge spaces, and phosphors are applied in the grooves.

20. The plasma display panel of claim 6, wherein the discharge spaces are filled with a discharge gas adapted to be excited by an electric discharge.

21. A plasma display panel comprising:
a first substrate;
a second substrate separated from the first substrate; and
a first electrode sheet and a second electrode sheet facing each other and between the first and second substrates, each of the first and second electrode sheets comprising opening patterns to form discharge spaces,
wherein each of the first and second electrodes sheets comprises:
a plurality of discharge electrodes comprising discharging portions, and conductive portions electrically connecting the discharging portions to each other, each of the discharging portions comprising a discharge surface surrounding a corresponding one of the discharge spaces and a corner with a round curved portion contacting a discharge surface of the corresponding one of the discharge spaces; and
at least one bridge integrally formed between adjacent discharge electrodes to support the discharge electrodes and to insulate the discharge electrodes from each other.

22. The plasma display panel of claim 21, wherein the curved portions are formed along upper and lower corners contacting the discharge surfaces.

23. The plasma display panel of claim 21, wherein the at least one bridge comprises an oxide of a metal used to form the discharge electrodes.

24. The plasma display panel of claim 21, wherein a width of the at least one bridge is narrower than a width of each of the conductive portions.

25. The plasma display panel of claim 21, wherein an oxide film having an insulating property is formed along a surface of the each of the discharge electrodes.

26. The plasma display panel of claim 21, wherein the discharge electrodes of the first electrode sheets extend in a first direction, and the discharge electrodes of the second electrode sheet extend in a second direction crossing the first direction.

27. The plasma display panel of claim 21, wherein the at least one bridge extends between the discharge electrodes in a direction crossing directions in which the discharge electrodes extend.

28. The plasma display panel of claim 21, wherein the at least one bridge is formed between the discharging portions of the adjacent discharge electrodes.

29. The plasma display panel of claim 21, wherein a plurality of grooves are formed on at least one of the first substrate or the second substrate to correspond to the discharge spaces, and phosphors are applied in the grooves.

30. A method of manufacturing a plasma display panel comprising a plurality of discharge spaces arranged in arrays, a plurality of discharge electrodes extending in a direction and surrounding at least a part of the discharge spaces, and an insulating layer connecting the discharge electrodes and electrically isolating the discharge electrodes from each other, the method comprising:
preparing a raw material metal sheet;
forming a first photoresist (PR) mask to cover portions where the discharge electrodes are to be formed on a surface of the raw material metal sheet;
forming a second PR mask to cover portions where the discharge electrodes are to be formed on another surface of the raw material metal sheet;
selectively etching the surface of the raw material metal sheet exposed by the first PR mask;
selectively etching the another surface of the raw material metal sheet exposed by the second PR mask;
separating the first PR mask and the second PR mask;
performing an anodizing process for oxidizing the raw material metal sheet in a neutral electrolysis solution to form an oxide film on surfaces of the discharge electrodes and for insulating portions between the discharge electrodes to form the insulating layer;
repeating the preparing process, the two forming processes, the two etching processes, the separating process, and the performing process to fabricate at least two metal sheets;
stacking the at least two metal sheets to face each other; and
coupling a first substrate and a second substrate to each other while interposing the stacked metal sheets using a frit sealing material.

31. The method of claim 30, wherein the neutral electrolysis solution comprises a material selected from the group consisting of ammonium borates, ammonium phosphate, ammonium tartrate, and combinations thereof.

32. The method of claim 30, wherein the raw material metal sheet is an aluminum sheet.

33. The method of claim 30, wherein portions of the raw material metal sheet where the discharge electrodes are to be formed are full-etched through the two etching processes.

34. The method of claim 30, wherein portions of the raw material metal sheet between the discharge electrodes are half-etched from both surfaces through the two etching processes so that some of the portions of the raw material metal sheet can remain.
